(19) United States
(12) Patent Application Publication
(10) Pub. No.: US 2019/0320649 A1
(43) Pub. Date: Oct. 24, 2019

(54) APPARATUS, SYSTEMS, AND METHODS FOR VASCULAR TISSUE PERFUSION

(71) Applicant: THE BOARD OF REGENTS OF THE UNIVERSITY OF TEXAS SYSTEM, Austin, TX (US)

(72) Inventor: Leonid BUNEGIN, San Antonio, TX (US)

(73) Assignee: THE BOARD OF REGENTS OF THE UNIVERSITY OF TEXAS SYSTEM, Austin, TX (US)

(21) Appl. No.: 16/467,529

(22) PCT Filed: Dec. 13, 2017
(86) PCT No.: PCT/US2017/066166

§ 371 Date: Jun. 7, 2019

Related U.S. Application Data
(60) Provisional application No. 62/433,577, filed on Dec. 13, 2016.

(51) Int. Cl. A01N 1/02

(52) U.S. Cl. CPC A01N 1/0247

(57) ABSTRACT

Devices and methods for vascular tissue perfusion. In certain embodiments, the pressurized oxygen is repetitively pulsed between a lower pressure and a higher pressure and a flexible membrane is deflected to control fluid flow.

### CROSS-REFERENCE TO RELATED APPLICATIONS

This application claims priority to U.S. Provisional Patent Application Ser. No. 62/433,577 filed, Dec. 13, 2016 the entire contents of which are incorporated herein by reference.

### BACKGROUND

Tissue can be perfused with oxygen to provide better preservation for replantation operations. For example, in combat and mass casualty situations, particularly where detonations have occurred, a significant number of severed extremities may appear. In order to facilitate replantation, extremities should be promptly preserved from deterioration, often for several hours to several days, so that the patient can be transported to a medical facility and stabilized before replantation is attempted. To assist in this process, research has identified the value of circulating a cold, specifically-formulated, oxygenated, fluid through a severed extremity so as to protect it from the lack of oxygen and other nutrients.

Existing devices can be difficult to transport and implement in field conditions due to limitations of size, weight, the availability of electrical power, operator training, etc. These limitations can lead to significant delays in the time before perfusion of the tissue can begin, reducing the length of time during which perfusion can be performed. Even when perfusion is applied in a timely fashion, the quantity of oxygen available to the perfused tissue may be less than what is desired.

### BRIEF DESCRIPTION OF THE DRAWINGS

The following drawings form part of the present specification and are included to further demonstrate certain aspects of the present disclosure. Various embodiments may be better understood by reference to one of these drawings in combination with the detailed description of specific embodiments presented herein.

FIG. 1 shows an exploded view of an embodiment of an apparatus for vascular tissue perfusion according to the present disclosure.

FIG. 2 shows a partial section view of the embodiment of FIG. 1.

FIG. 3 shows a perspective section view of the embodiment of FIG. 1.

FIG. 4 shows a partial section view of particular components of the embodiment of FIG. 1 in a first position.

FIG. 5 shows a partial section view of particular components of the embodiment of FIG. 1 in a second position.

FIG. 6 shows a partial section view of particular components of the embodiment of FIG. 1 in a third position.

FIG. 7 shows a flow diagram of a method of perfusing tissue, according to various embodiments.

FIG. 8 shows a graph of a perfusate oxygenation profile illustrating oxygen partial pressure over time.

FIG. 9 shows a graph of a perfusate oxygen content in and out during preservation.

FIG. 10 shows a graph of oxygen uptake during perfusion preservation.

### DETAILED DESCRIPTION

In conventional hollow fiber oxygenators, fluid and oxygen flows are continuous and generated by separate mechanisms. The fluid to be oxygenated is mechanically driven by a pump to flow around the outside surface of the hollow fibers, while oxygen flows passively through the lumen of the hollow fibers after passing through a stepdown pressure regulator. Energy stored in the compressed oxygen is wasted, being allowed to dissipate unused. The energy used to drive fluid around the hollow fibers of the oxygenator is often derived from external sources, such as a battery or wall outlet. Backflow though the oxygenator is prevented by the addition of external valve components, which are not an integral part of the oxygenator or pump mechanism, leading to additional complexity.

Accordingly, there is a need for devices and methods that address these and other shortcomings in existing devices. Various embodiments of the present disclosure relate generally to devices and methods for preservation and perfusion of vascular tissues, including vascular tissues associated with extremities, such as limbs. Most embodiments of the present disclosure relate to devices and methods for preserving tissue by perfusion.

Many embodiments provide a highly portable, inexpensive device into which a severed extremity (or other vascular tissue) can be placed, to retain vitality until the patient is ready for reattachment. For patients in need of a limb for transplantation, many embodiments can maintain the health of donor extremities for an extended period of time, such as the total time needed to separate the limb from the donor, to transport the limb from the donor hospital to the transplant hospital, to match the limb to the recipient, to reattach the limb to the recipient, and even longer. Accordingly, geographical limitations from which donor extremities can be obtained can be reduced or eliminated through use of the embodiments disclosed herein. This advancement in perfusion technology can be valuable to the military, as well as the civilian population, particularly in the face of traumatic avulsion.

In the embodiments described herein, oxygen permeable capillaries of an oxygenator (in combination with a pumping membrane, which may comprise a conical pumping membrane) are integrated to achieve three functions in parallel. The first function is to drive perfusate though the attached limb or other vascular tissue. The second function is to prevent retrograde flow of perfusion fluid though the oxygen permeable capillaries of the oxygenator. The third function is to oxygenate the perfusate. In most embodiments, all three functions may be executed substantially simultaneously, which means that at some point in time, all three functions occur together. Additional discussion of the features that provide these functions follows below.

Many embodiments can harvest the energy stored in compressed oxygen, as it expands to reach ambient pressure (e.g., as it exits a pressure regulator used to control the oxygen pressure). This harvested energy can be used to circulate the preservation perfusate. For example, the combination of the oxygenator and pumping mechanism with an electronically driven microfluidic valve (or a pneumatically-driven fluidics monostable logic gate operating in a pulsatile fashion) can be used to harvest the energy from the compressed oxygen. The ability to harvest such energy (as well as other design features) permits most embodiments to provide metabolic support to avulsed limbs for extended periods of time—potentially much longer than existing devices, which are usually only effective for twelve hours, or less.

During operation, various embodiments operate to direct preservation fluid flow through the lumens of oxygen-permeable capillaries while bathing the exterior of the capillaries with oxygen. Accordingly, the greater surface area of the exterior of the capillaries relative to the interior surface area of those same capillaries provides an oxygenation advantage over conventional devices where the interior of the capillaries is used to transport oxygen, while the exterior of the capillaries is used to transport fluid. Thus, in various embodiments, the smaller cross-section of the fluid column passing through the oxygen permeable capillaries results in a shorter diffusion path with the advantage of providing a greater amount of oxygen to the fluid in a shorter length of time (when compared to conventional devices). Using a pulsatile flow through the oxygenator increases the oxygenation advantage by allowing the fluid to remain in the capillaries for a longer period of time, increasing the available oxygen diffusion time.

Some embodiments include a pumping membrane with a conical or inverted funnel shape. A pumping membrane with a conical shape can also act as a bubble trap (i.e., a pumping membrane and bubble trap as a single element), to reduce gas embolization in the attached tissue. Additionally, the pumping membrane can be formed from an oxygen permeable material in certain embodiments. This can provide additional oxygenation capacity to the perfusion fluid. For example, a pumping membrane having oxygen permeability characteristics can allow additional oxygen to diffuse into the perfusate and increase the dissolved oxygen content of the perfusing fluid. This can in turn deliver more oxygen to the tissue and provide metabolic support for a larger mass of tissue (as compared to a membrane without oxygen permeability characteristics).

In some embodiments, the oxygenator configuration described above provides a compact form factor with a relatively high ratio of the surface area of the oxygenating membrane to the volume of perfusate being oxygenated at a given instant. In many embodiments, this ratio ranges from 100:1 to 300:1. In addition, the inherent compliance of a base portion of the device housing can enhance recirculation of the perfusate and eliminate the need for a compliant tissue canister. This can provide for a robust canister design that can provide protection to the tissue contained within. Specific embodiments may be made of biodegradable materials and may be disposable in certain cases.

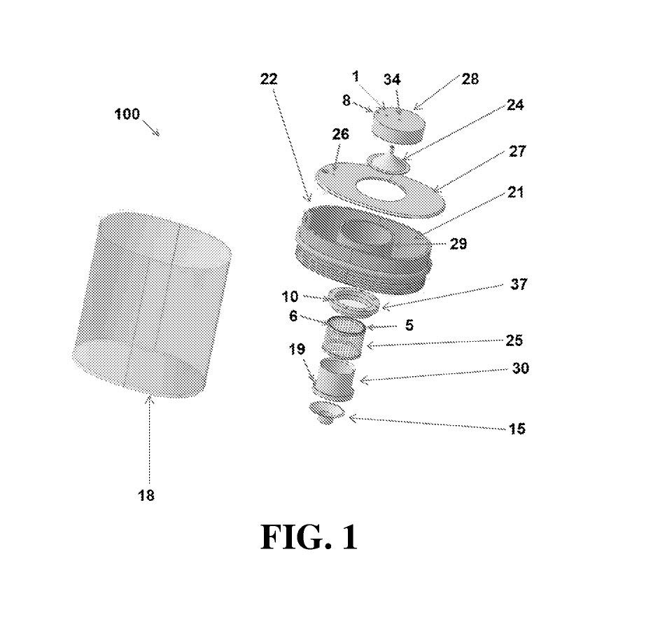

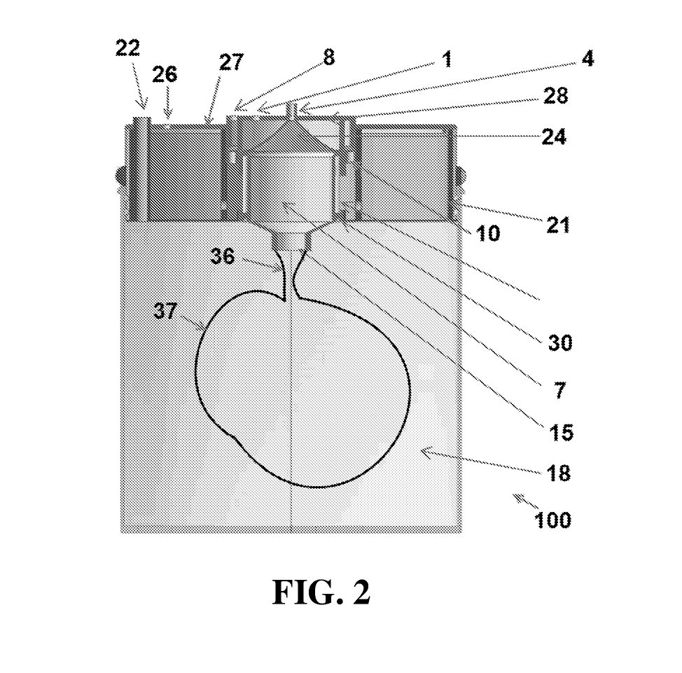

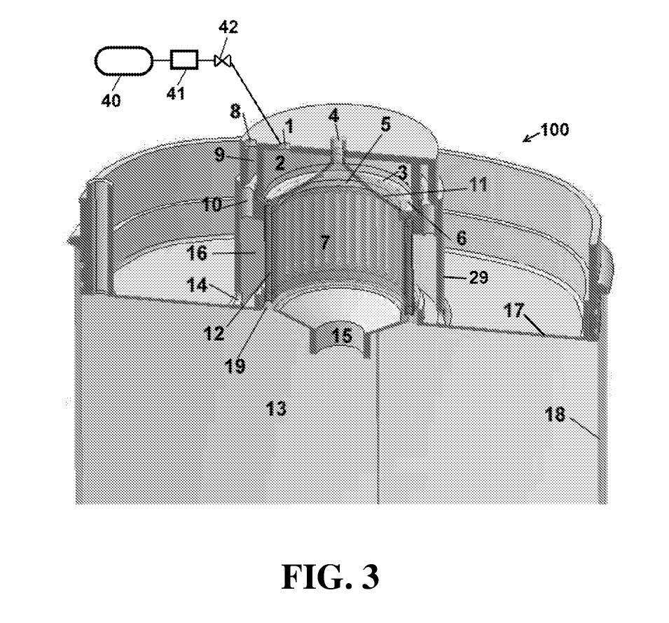

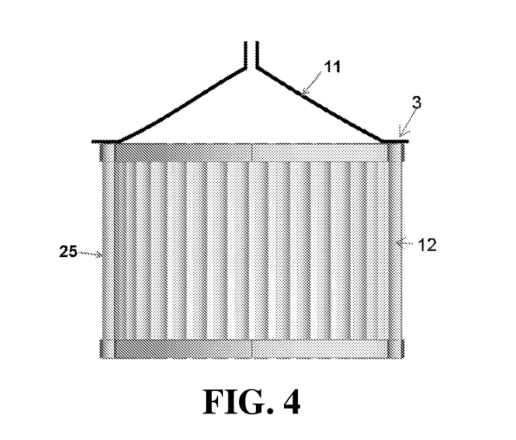

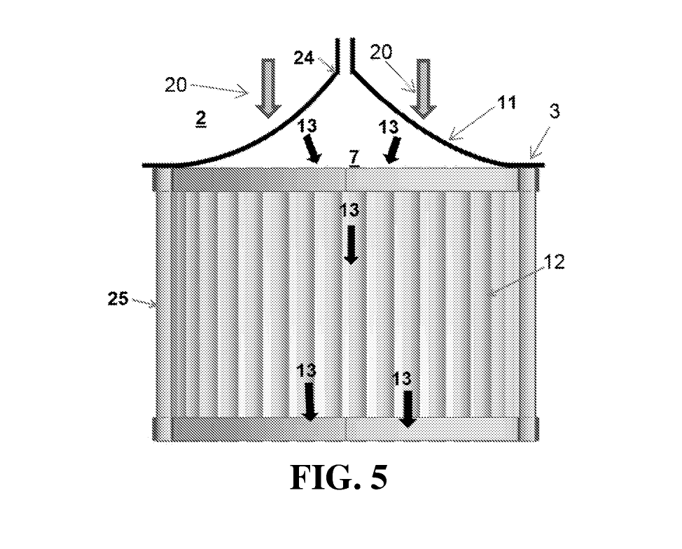

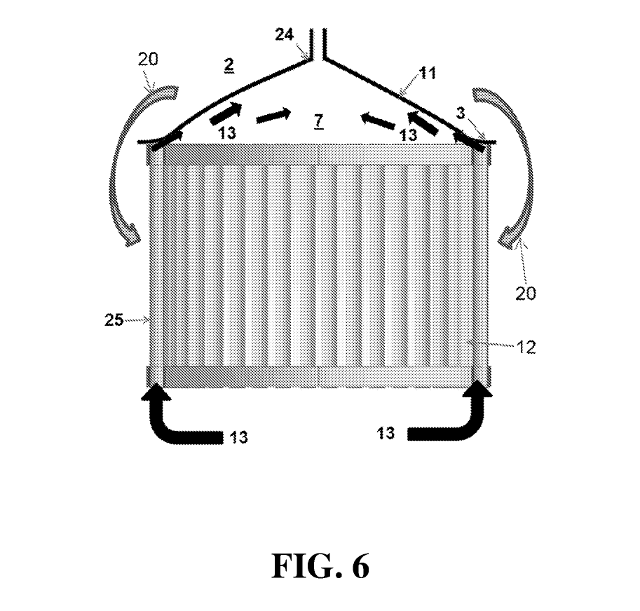

Thus, most embodiments include devices and methods for vascular tissue perfusion. Referring initially to FIG. 1, an exploded view is shown of an apparatus 100 for vascular tissue perfusion. Apparatus 100 is also shown in a partial section view in FIG. 2, while FIG. 3 illustrates a perspective partial section view. FIGS. 4-6 illustrate specific components in different positions and fluid flow during operation of apparatus 100. In particular, FIG. 4 illustrates the components before pressurization, FIG. 5 illustrates the components during pressurization, and FIG. 6 illustrates the components during the diastolic (de-pressurization) phase.

An overview of apparatus 100 and its operation will now be provided, followed by more detailed discussion of various aspects. For purposes of clarity, not all components are labeled with reference numbers in every figure.

Apparatus 100 comprises a tissue compartment 18, a housing 21 (with a lid 27, a fill port 22 and a central channel 29), an oxygenator 25 (with conduits 12 and orifice plate 5 with plate orifices 6), and a pumping diaphragm 24 (with a purge port 4 and a flange 3). In addition, the apparatus 100 comprises a pump chamber cap 28 with a vent port 8, a gas supply port 1, and an outlet 34 aligned with a purge port 4. The apparatus 100 further comprises an oxygenator retaining ring 37 with ring orifices 10, and an oxygenator support 30 with support orifices 19. These components can be assembled as shown in the section views of FIGS. 2 and 3.

Prior to operation of the apparatus 100, an arterial vessel 36 of vascular tissue 37 may be coupled to an outflow channel or port 15. In certain embodiments, vascular tissue 37 may be part of a severed extremity or limb that is contained within the tissue compartment 18. In some embodiments, a venous vessel of the tissue is left free (e.g., not coupled to channel 15 or any other port) to discharge fluid into the compartment 18. In preparation for operation of the apparatus 100, compartment 18 can be partially filled with preservation solution 13, and housing 21 can be inserted into compartment 18, partially submerging the vascular tissue to be perfused. In certain embodiments, compartment 18 can be of sufficient size and volume to accept an entire human leg or arm, or reduced in size to accept a variety of smaller vascular tissues.

Additional preservation solution can be added through fill port 22, filling compartment 18 and completely submerging the vascular tissue. Preservation fluid 13 can continue to flow up through conduits 12 of the oxygenator 25, filling a channel 7 (e.g., a volume located in the interior region of the oxygenator support 30, between pumping diaphragm 24 and outflow channel 15). Preservation fluid 13 is permitted to exit the purge port 4 of pumping diaphragm 24. The fill port 22 and purge port 4 can then be closed, and chamber 2 can be pressurized with oxygen, perhaps using intermittent pulses delivered through the gas supply port 1, as explained further below.

During operation of the apparatus 100, oxygen 20 at higher pressure (e.g., pressure that is higher than the ambient pressure surrounding the apparatus 100) enters chamber 2 to exert a force on pumping diaphragm 24, resulting in a downward deflection of surface 11 of diaphragm 24, moving the surface 11 closer to the oxygenator 25, as shown in FIG. 5. The upper ends of conduits 12 (e.g. the ends proximal to flange 3 of diaphragm 24) of the oxygenator 25 are occluded by flange 3 and the pressure within the chamber 2 increases. The deflection of surface 11 forces preservation fluid 13 from channel 7 down through outflow channel 15 (shown in FIG. 3) and into the arterial vessel of the vascular tissue coupled to outflow channel 15.

In some embodiments, a control system 41 with a valve 42 can be used to control a source 40 of pressurized oxygen that is pulsed through chamber orifice 1 into chamber 2 to generate the increased pressure within the chamber 2. In certain embodiments valve 42 may be a pneumatic valve, and control system 41 may comprise an electronic circuit that controls valve 42. For example, control system 41 can open valve 42 to admit oxygen through port 1 into chamber 2, and then close valve 42 to allow oxygen from chamber 2 to exhaust through port 8.

Particular embodiments may include a fluidic configuration, in which oxygen exits the source 40 of pressurized oxygen into port 1, pressurizing chamber 2. When the pressure in pumping chamber 2 exceeds a preset pressure, feedback diverts oxygen flow from port 1 to exhaust port 8.

As previously noted, the increased oxygen pressure holds flange 3 of pumping diaphragm 24 securely against orifice plate 5, occluding plate orifices 6 at the upper ends of conduits 12, to prevent back flow. Substantially simultaneously, oxygen 20 can diffuse through surface 11 (which is oxygen permeable in some embodiments) to oxygenate the preservation fluid 13 in channel 7.

After perfusing the vascular tissue, preservation fluid 13 exits the venous vessel and travels into the compartment 18. Housing 21 includes a base plate 17 that flexes upward (e.g., away from the vascular tissue coupled to outflow channel 15) to accommodate the increased volume of preservation solution 13 flowing into compartment 18. Between the times that pulses of higher pressure enter the chamber 2, the pressure in chamber 2 is reduced by venting oxygen through vent orifice 8 into chamber 9, and through ring orifices 10 of ring 37 into vent chamber 16. Allowing oxygen in chamber 2 to vent in this manner also allows oxygen 20 to pass around conduits 12 as shown in FIG. 6. This can remove carbon dioxide and oxygenate the preservation solution within conduits 12. The oxygen in vent chamber 16 can flow through housing orifice 14 into housing 21 and exhaust through the exhaust port 26 in housing lid 27 to the atmosphere surrounding the apparatus 100.

The recoil of the base plate 17 (e.g. downward from its previous upward deflection toward vascular tissue coupled to outflow channel 15) reduces the effective volume of compartment 18 and forces preservation solution 13 up through the oxygenator orifices 19 and conduits 12 of oxygenator 25. The pressure gradient between the vascular tissue storage compartment 18 and chamber 2 causes the preservation solution 13 to lift the pumping membrane flange 3, so as to accumulate in channel 7, as shown in FIG. 6. This activity displaces the oxygenated solution from conduits 12, into channel 7, in preparation for the next cycle. The cycle repeats as oxygen is pulsed through chamber orifice 1 into chamber 2 at the higher pressure (i.e., than the ambient pressure surrounding the apparatus 100).

The means by which pressure is delivered to chamber orifice 1 may comprise a microfluidic valve controlled by electronic circuitry to produce a pulsatile pattern. Other embodiments may employ a fluidics monostable logic gate such as an OR gate or an OR/NOR gate. Both devices can have internal channels for directing exhaust oxygen to orifice 8.

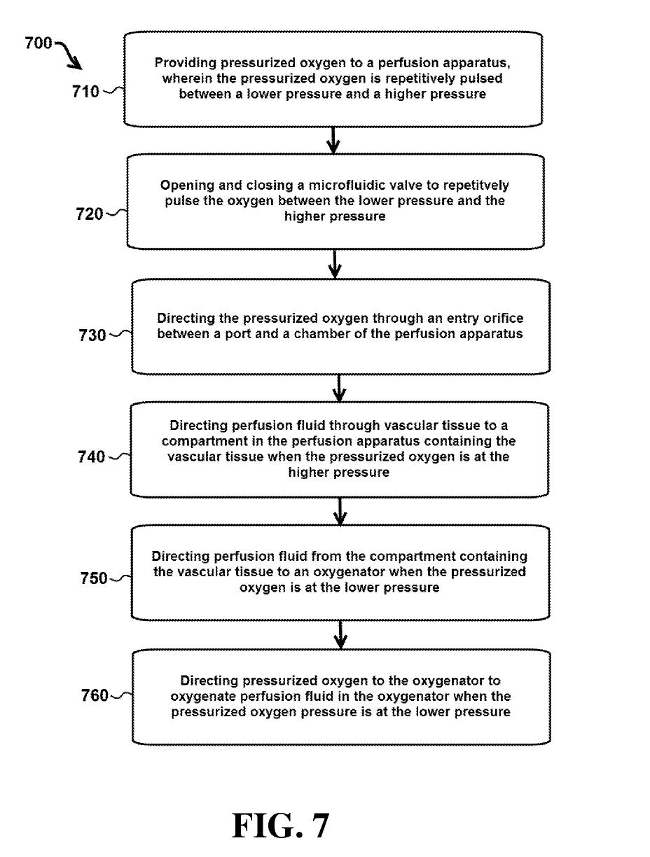

Referring now to FIG. 7, a flow diagram 700 is shown illustrating steps 710-760 performed in exemplary methods according to the present disclosure. It is understood the steps do not necessarily need to be performed in the sequential order presented in flow diagram 700 in all embodiments. Step 710 comprises providing pressurized oxygen to a perfusion apparatus, wherein the pressurized oxygen is repetitively pulsed between a lower pressure and a higher pressure. Step 720 comprises opening and closing a microfluidic valve to repetitively pulse the oxygen between the lower pressure and the higher pressure, while step 730 comprises directing the pressurized oxygen through an entry orifice between a port and a chamber of the perfusion apparatus. Step 740 comprises Directing perfusion fluid through vascular tissue to a compartment in the perfusion apparatus containing the vascular tissue when the pressurized oxygen is at the higher pressure, and step 750 comprises directing perfusion fluid from the compartment containing the vascular tissue to an oxygenator when the pressurized oxygen is at the lower pressure. Step 760 comprises directing pressurized oxygen to the oxygenator to oxygenate perfusion fluid in the oxygenator when the pressurized oxygen pressure is at the lower pressure.

As disclosed herein, exemplary embodiments of the present disclosure include an apparatus for vascular tissue perfusion. In certain embodiments, the apparatus comprises: an oxygenator comprising a first end, a second end, and a plurality of conduits extending from the first end to the second end; and a flexible membrane comprising a first side and a second side. In particular embodiments, the first side of the flexible membrane is proximal to the first end of the oxygenator; the flexible membrane is configured to restrict fluid flow through the plurality of conduits when the second side of the flexible membrane is subjected to a higher pressure than the first side of the flexible membrane; and the flexible membrane is configured to allow fluid flow through the plurality of conduits when the first side of the flexible membrane is subjected to a higher pressure than the second side of the flexible membrane.

In specific embodiments, the flexible membrane is conical shaped. In certain embodiments, the first end comprises a port and the second end comprises a flange. In particular embodiments, the flange of the flexible membrane is configured to deflect away from the first end of the oxygenator when the first side of the flexible membrane is subjected to a higher pressure than the second side of the flexible membrane. In some embodiments, the flexible membrane is oxygen permeable. In specific embodiments, the flexible membrane comprises a tapered portion having a first end and a second end, and the first end has a smaller cross-sectional area than the second end.

Certain embodiments further comprise a central channel, where the plurality of conduits are located around the central channel, and where the flexible membrane is configured to force fluid flow through the central channel when the second side of the flexible membrane is subjected to a higher pressure than the first side of the flexible membrane. Particular embodiments, further comprise a chamber extending the central channel, where the plurality of conduits are located within the chamber. In some embodiments, the chamber is in fluid communication with a source of pressurized oxygen.

Specific embodiments further comprise a compartment configured to contain vascular tissue, where the central channel of the oxygenator is in fluid communication with the compartment configured to contain vascular tissue, and where the compartment comprises an opening to an interior volume of the compartment. Certain embodiments further comprise a housing coupled to the opening of the compartment, where the housing comprises a flexible base plate proximal to the interior volume of the compartment.

In particular embodiments, the flexible base plate is configured to flex away from the interior volume of the compartment when the second side of the flexible membrane is subjected to a higher pressure than the first side of the flexible membrane. Some embodiments further comprise an outflow port coupled to the central channel of the oxygenator, where the outflow port is in fluid communication with the interior volume of the compartment. Specific embodiments further comprise vascular tissue, where the vascular tissue is located in the compartment. In certain embodiments, the vascular tissue comprises an arterial vessel coupled to the outflow port. Particular embodiments further comprise a tissue preservation solution in the compartment, the central channel of the oxygenator, and the plurality of conduits of the oxygenator. In particular embodiments, the vascular tissue is contained in a limb. Some embodiments further comprise a control system configured to pulse the higher pressure to the first side of the flexible member. In specific embodiments, the control system comprises a microfluidic valve.

Certain embodiments include a method of vascular tissue perfusion, where the method comprises: providing pressurized oxygen to a perfusion apparatus, wherein the pressurized oxygen is repetitively pulsed between a lower pressure and a higher pressure; directing perfusion fluid through vascular tissue to a compartment in the perfusion apparatus containing the vascular tissue when the pressurized oxygen is at the higher pressure; directing perfusion fluid from the compartment containing the vascular tissue to an oxygenator when the pressurized oxygen is at the lower pressure; and directing pressurized oxygen to the oxygenator to oxygenate perfusion fluid in the oxygenator when the pressurized oxygen pressure is at the lower pressure.

In particular embodiments of the method, the perfusion device comprises a chamber in fluid communication with a port and an exhaust orifice, the oxygenator comprises a plurality of conduits comprising the perfusion fluid, the plurality of conduits are located within the chamber, and directing the pressurized oxygen to the oxygenator comprises directing the pressurized oxygen through the port, into the chamber, and out of the exhaust orifice. Specific embodiments of the method further comprise directing the pressurized oxygen through an entry orifice between the port and the chamber. In certain embodiments of the method, directing the perfusion fluid through vascular tissue comprises deflecting a flexible membrane when the pressurized oxygen is at the higher pressure. In particular embodiments of the method, the flexible membrane operates to direct fluid through a channel extending through a central portion of the oxygenator when the pressurized oxygen is at the higher pressure.

In specific embodiments of the method, a volume of the compartment containing the vascular tissue expands when perfusion fluid flows from the vascular tissue to the compartment containing the vascular tissue. In certain embodiments of the method, the volume of the compartment containing the vascular tissue contracts when the pressurized oxygen is at the lower pressure. In particular embodiments of the method, a flexible plate flexes to expand the volume of the compartment containing the vascular tissue, and in specific embodiments of the method the flexible plate flexes to contract the volume of the compartment containing the vascular tissue. In certain embodiments of the method, perfusion fluid is directed from the compartment containing the vascular tissue to the oxygenator when the flexible plate flexes. In certain embodiments, the pressurized oxygen is repetitively pulsed between the lower pressure and the higher pressure by opening and closing a microfluidic valve.

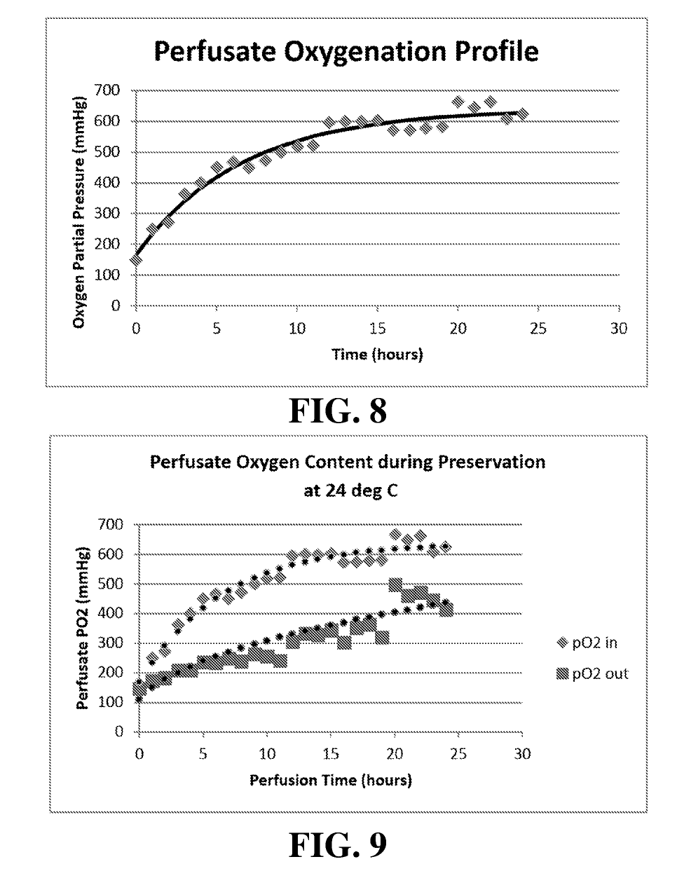

FIGS. 8-10 include graphs that illustrate perfusate oxygenation data and oxygen uptake during perfusion preservation utilizing apparatus and methods according to the present disclosure. In particular, FIG. 8 shows a graph of a perfusate oxygenation profile illustrating oxygen partial pressure over time at 24 degrees Celsius. As shown in FIG. 8, the oxygen partial pressure is initially between 100 and 200 mmHg and increases to a level between 600 and 700 mmHg over a period of approximately 24 hours.

FIG. 9 shows a graph of a perfusate oxygen content into and out of rodent hind limbs during perfusion preservation over time at 24 degrees Celsius. The perfusate oxygen content into the limbs (represented by diamonds in the graph) begins at a level between 150 and 200 mmHG and increases to a level between 600 and 700 mmHg over a period of approximately 24 hours. The perfusate oxygen content out of the limbs (represented by squares) begins at a level slightly above 100 mmHG and increases to a level between 400 and 500 mmHg. The difference in the oxygen levels into and out of the limbs represents oxygen extraction by limb tissue.

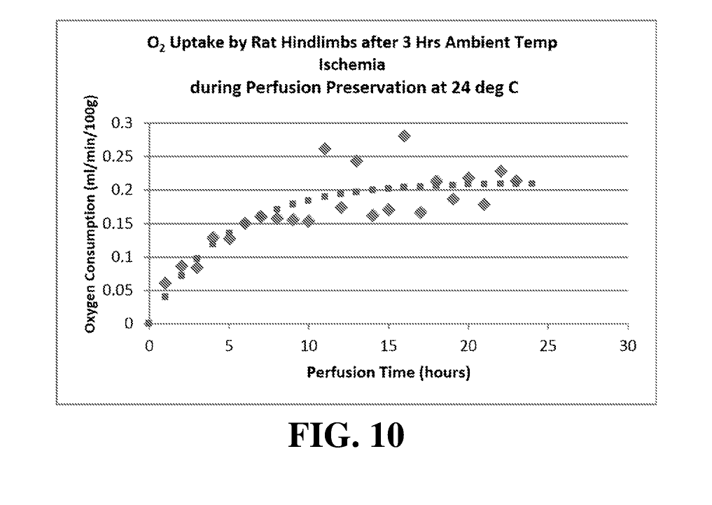

FIG. 10 shows a graph of oxygen uptake by rodent hind limbs during preservation over time at 24 degrees Celsius (after three hours of ambient temperature ischemia). As shown in FIG. 10, the oxygen uptake or consumption increases from zero to approximately 0.21 ml/min/100 g over a period of approximately 24 hours.

In the preceding discussion, the term “coupled” is defined as connected, although not necessarily directly, and not necessarily mechanically. Thus, one element may be directly, mechanically coupled to another, as is the case with the purge port 4 of the pumping diaphragm 24. An element may also be indirectly, fluidly coupled to another, as is the case (during operation) of the base plate 17 and the pumping membrane flange 3.

The use of the word “a” or “an” when used in conjunction with the term “comprising” in the claims and/or the specification may mean “one,” but it is also consistent with the meaning of “one or more” or “at least one.” The terms “about”, “approximately” or “substantially” mean, in general, the stated value plus or minus 5%. The use of the term “or” in the claims is used to mean “and/or” unless explicitly indicated to refer to alternatives only or the alternative are mutually exclusive, although the disclosure supports a definition that refers to only alternatives and “and/or.”

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more acts or elements, possesses those one or more acts or elements, but is not limited to possessing only those one or more elements. Likewise, an act in a method or an element of a device that “comprises,” “has,” “includes” or “contains” one or more features, possesses those one or more features, but is not limited to possessing only those one or more features. Furthermore, a device or structure that is configured in a certain way is configured in at least that way, but may also be configured in ways that are not listed.

All of the apparatus, systems and/or methods disclosed and claimed herein can be made and executed without undue experimentation in light of the present disclosure. While these apparatus, systems and methods have been described in terms of particular embodiments, it will be apparent to those of ordinary skill in the art that variations may be applied to the apparatus, systems and/or methods without departing from the scope of this disclosure. All such similar subs titutes and modifications apparent to those of ordinary skill in the art are deemed to be within the scope of this disclosure, as defined by the appended claims.

### REFERENCES

The contents of the following references are incorporated in their entirety by reference herein:
U.S. Pat. No. 4,837,390
U.S. Pat. No. 6,677,150
U.S. Pat. No. 7,176,015
U.S. Pat. No. 8,685,709
U.S. Pat. No. 9,253,976
U.S. Pat. No. 9,301,519
U.S. Pat. No. 9,408,959
U.S. Patent Publication 20030054540
U.S. Patent Publication 20050136125
U.S. Patent Publication 20090291486
U.S. Patent Publication 20120157879
U.S. Patent Publication 20120301952
U.S. Patent Publication 20120309078
U.S. Patent Publication 20130130359
U.S. Patent Publication 20150230453
U.S. Patent Publication 20150297397
U.S. Patent Publication 20160113270
PCT Patent Publication WO2005011569
PCT Patent Publication WO2005012480
PCT Patent Publication WO2005016234
PCT Patent Publication WO2008077059
PCT Patent Publication WO2012125782
CA2542806A1
DE19622184
DE4407863
EP2598185
EP0842261A1
SG55168A1

1. An apparatus for vascular tissue perfusion, the apparatus comprising:
an oxygenator comprising a first end, a second end, and a plurality of conduits extending from the first end to the second end; and
a flexible membrane comprising a first side and a second side, wherein:
the first side of the flexible membrane is proximal to the first end of the oxygenator;
the flexible membrane is configured to restrict fluid flow through the plurality of conduits when the second side of the flexible membrane is subjected to a higher pressure than the first side of the flexible membrane; and
the flexible membrane is configured to allow fluid flow through the plurality of conduits when the first side of the flexible membrane is subjected to a higher pressure than the second side of the flexible membrane.

2. The apparatus of claim 1 wherein the flexible membrane is conical shaped.

3. The apparatus of claim 2 wherein the first end comprises a port and the second end comprises a flange.

4. The apparatus of claim 3 wherein the flange of the flexible membrane is configured to deflect away from the first end of the oxygenator when the first side of the flexible membrane is subjected to a higher pressure than the second side of the flexible membrane.

5. The apparatus of claim 3 wherein the flexible membrane is oxygen permeable.

6. The apparatus of claim 1 wherein the flexible membrane comprises a tapered portion having a first end and a second end, and wherein the first end has a smaller cross-sectional area than the second end.

7. The apparatus of claim 1 further comprising a central channel, wherein:
the plurality of conduits are located around the central channel; and
the flexible membrane is configured to force fluid flow through the central channel when the second side of the flexible membrane is subjected to a higher pressure than the first side of the flexible membrane.

8. The apparatus of claim 7, further comprising a chamber extending the central channel, wherein the plurality of conduits are located within the chamber.

9. The apparatus of claim 8 wherein the chamber is in fluid communication with a source of pressurized oxygen.

10. The apparatus of claim 7, further comprising a compartment configured to contain vascular tissue, wherein:
the central channel of the oxygenator is in fluid communication with the compartment configured to contain vascular tissue; and
the compartment comprises an opening to an interior volume of the compartment.

11. The apparatus of claim 10 further comprising a housing coupled to the opening of the compartment, wherein the housing comprises a flexible base plate proximal to the interior volume of the compartment.

12. The apparatus of claim 11 wherein the flexible base plate is configured to flex away from the interior volume of the compartment when the second side of the flexible membrane is subjected to a higher pressure than the first side of the flexible membrane.

13. The apparatus of claim 12 further comprising an outflow port coupled to the central channel of the oxygenator, wherein the outflow port is in fluid communication with the interior volume of the compartment.

14. The apparatus of claim 13 further comprising vascular tissue, wherein the vascular tissue is located in the compartment.

15. The apparatus of claim 14 wherein the vascular tissue comprises an arterial vessel coupled to the outflow port.

16. The apparatus of claim 14 further comprising a tissue preservation solution in the compartment, the central channel of the oxygenator, and the plurality of conduits of the oxygenator.

17. The apparatus of claim 14 wherein the vascular tissue is contained in a limb.

18. The apparatus of claim 1 further comprising a control system configured to pulse the higher pressure to the first side of the flexible member.

19. The apparatus of claim 18 wherein the control system comprises a microfluidic valve.

20. A method of vascular tissue perfusion, the method comprising:
providing pressurized oxygen to a perfusion apparatus, wherein the pressurized oxygen is repetitively pulsed between a lower pressure and a higher pressure;
directing perfusion fluid through vascular tissue to a compartment in the perfusion apparatus containing the vascular tissue when the pressurized oxygen is at the higher pressure;
directing perfusion fluid from the compartment containing the vascular tissue to an oxygenator when the pressurized oxygen is at the lower pressure; and
directing pressurized oxygen to the oxygenator to oxygenate perfusion fluid in the oxygenator when the pressurized oxygen pressure is at the lower pressure.

21. The method of claim 20 wherein:
the perfusion device comprises a chamber in fluid communication with a port and an exhaust orifice;
the oxygenator comprises a plurality of conduits comprising the perfusion fluid, and the plurality of conduits are located within the chamber; and
directing the pressurized oxygen to the oxygenator comprises directing the pressurized oxygen through the port, into the chamber, and out of the exhaust orifice.

22. The method of claim 21 further comprising directing the pressurized oxygen through an entry orifice between the port and the chamber.

23. The method of claim 20 wherein directing the perfusion fluid through vascular tissue comprises deflecting a flexible membrane when the pressurized oxygen is at the higher pressure.

24. The method of claim 23 wherein the flexible membrane operates to direct fluid through a channel extending through a central portion of the oxygenator when the pressurized oxygen is at the higher pressure.

25. The method of claim 20 wherein a volume of the compartment containing the vascular tissue expands when perfusion fluid flows from the vascular tissue to the compartment containing the vascular tissue.

26. The method of claim 25 wherein the volume of the compartment containing the vascular tissue contracts when the pressurized oxygen is at the lower pressure.

27. The method of claim 25 wherein a flexible plate flexes to expand the volume of the compartment containing the vascular tissue.

28. The method of claim 26 wherein the flexible plate flexes to contract the volume of the compartment containing the vascular tissue.

29. The method of claim 28 wherein perfusion fluid is directed from the compartment containing the vascular tissue to the oxygenator when the flexible plate flexes.

30. The method of claim 20, wherein the pressurized oxygen is repetitively pulsed between the lower pressure and the higher pressure by opening and closing a microfluidic valve.
